(19) United States
(12) Patent Application Publication
(10) Pub. No.: US 2009/0265093 A1
(43) Pub. Date: Oct. 22, 2009

(54) Destination search support device, methods, and programs

(75) Inventor: Hiroshi Kawauchi, Kariya (JP)

Correspondence Address: OLIFF & BERRIDGE, PLC, P.O. BOX 320850, ALEXANDRIA, VA, 22320-4850, US

(73) Assignee: AISIN AW CO., LTD., ANJO-SHI (JP)

(21) Appl. No.: 12/379,164

(22) Filed: Feb. 13, 2009

(30) Foreign Application Priority Data
Mar. 6, 2008 (JP) 2008-056645

(51) Int. Cl. G01C 21/00

(52) U.S. Cl. 701/200

(57) ABSTRACT

A navigation device, when a destination candidate is deleted, postpones the deletion by providing a deletion deadline for the destination candidate. This makes it possible to search for the destination candidate even if it is eligible for deletion. If a user sets as the destination a destination candidate whose deletion has been postponed, then the destination candidate is displayed differently to make the user aware that the deletion has been postponed. If a destination candidate for which the deletion deadline has been set is set as the destination, then the navigation device compares the deletion deadline to a date that is m months after the current date, and if the m months later date is later than the deletion deadline, the navigation device extends the deletion deadline by updating it to the m months later date. This postpones the deletion of a destination candidate that the user considers necessary.

### CROSS-REFERENCE TO RELATED APPLICATION

The disclosure of Japanese Patent Application No. 2008-056645 filed on Mar. 6, 2008, including the specification, drawings and abstract is incorporated herein by reference in its entirety.

### BACKGROUND OF THE INVENTION

1. Related Technical Fields

The present invention relates to a destination search support device and a destination search support program for setting a destination in a navigation device, for example.

2. Related Art

In recent years, the guidance of vehicles by navigation devices has become increasingly common. A navigation device has a function that searches for a route from a departure point to a destination, a function that detects the vehicle's position using the Global Positioning System (GPS) satellites and a sensor such as a gyroscope or the like, a function that displays the vehicle's current position and the route to the destination on a map, and the like.

Generally, a destination is input when the navigation device is used to search for a route, to search for a facility in the vicinity of the current position, to check information on the facility, and the like. The destination input is done by searching a destination data file to find destination candidates that correspond to characters that are input and displaying the destination candidates. The input of the destination is completed by selecting one of the displayed destination candidates. Map information must be updated due to changes in the facilities at the destination, such as the removal of a facility, a change of name, and the like.

In Japanese Patent Application Publication No. JP-A-H08-305282, a map information update method and a route guidance system for a mobile unit are described as a technology for performing this sort of map update. The technology efficiently updates the vehicle's maps by transmitting the update changes for the map information from a center to the vehicle.

With the development of the naming rights industry in recent years, there are situations where the name of a facility is changed only for a fixed time period. The naming rights industry provides a business model for obtaining compensation in exchange for granting a facitily's naming rights to a third party for a fixed time period. For example, the naming rights to a stadium called Minato-Ku Stadium may be leased to a company called Nekusuto Amusement Corporation for a fixed time period, and Nekusuto Amusement Corporation may rename Minato-Ku Stadium to Nekusuto Stadium for that fixed period.

In recent years, the names of facilities have been changed frequently due to the elimination and consolidation of businesses, the naming rights industry, and the like. However, in known navigation devices, when the name of a facility or the like changes, the old name that was used before the change is deleted from the map information.

### SUMMARY OF THE INVENTION

In some situations, the user does not necessarily know the most recent name of a facility, and as a result, the user searches for the facility by using the old name. This creates a problem if the old name has been deleted because the facility cannot therefore be found by the search. In other situations, a user may use a navigation device for a fixed period of time to visit the facility, even if a facility is closed. In a situation where only the name has changed and everything else about a facility remains the same, the inability to find the facility using the old name may cause the user to wrongly believe that the facility is closed.

Various implementations of the broad principles herein described provide a destination support device, method, and program with the capacity to perform a flexible search with regard to variations in a facility's name and the like.

Exemplary implementations of the inventive principles described herein provide devices, methods, and programs that store a plurality of destination candidates for which search expiration dates are set; input a search term; search among the destination candidates in the information storage unit for the destination candidates that correspond to the search term; and set as a destination one of the destination candidates that is found by the search. The devices, methods, and programs may extend the search expiration date for a destination candidate when the destination candidate is set as the destination within a specified period before the search expiration date that is set for the destination candidate; and delete from the information storage unit the destination candidates for which the search expiration dates have passed.

### BRIEF DESCRIPTION OF THE DRAWINGS

FIG. 1 is a system configuration diagram of an exemplary navigation device;

FIG. 2 illustrates an example of a logical configuration of a destination data file;

FIG. 3 illustrates an exemplary method of extending a deletion deadline for a destination candidate;

FIG. 4 illustrates an exemplary candidate display screen; and

FIG. 5 illustrates an exemplary procedure that extends the deletion deadline for the destination candidate.

### DETAILED DESCRIPTION OF EXEMPLARY IMPLEMENTATIONS

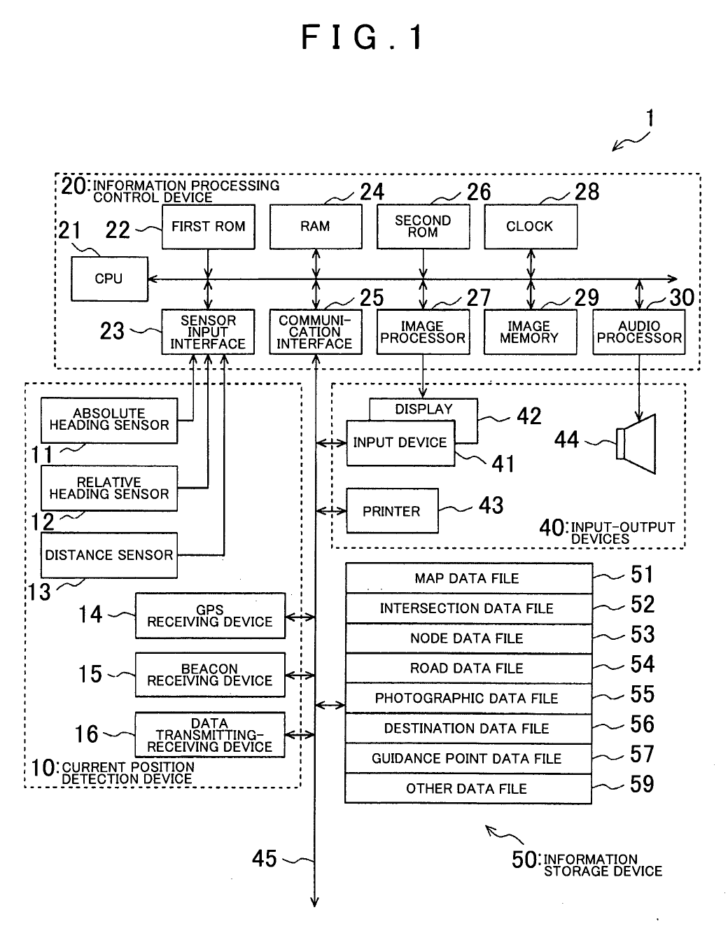

An exemplary destination search support device, usable in a navigation device, will be described in detail. At least three exemplary situations exist where such a device can be used. (1) When a destination candidate will be deleted due to a change of name for a facility, a removal or closure of a facility, or the like, a navigation device 1 (FIG. 1) provides a deletion deadline for the destination candidate and postpones the deletion. This makes it possible to search for a destination candidate even if it is eligible for deletion. (2) When a user sets as a destination a destination candidate for which the deletion has been postponed, the navigation device 1 makes the user aware that the deletion of the destination candidate has been postponed by changing the way that the destination candidate is displayed or the like. (3) When a destination candidate for which the deletion deadline has been set is set as the destination, the navigation device 1 compares the deletion deadline to a date that is m months after the current date. If the date that is m months after the current date is later than the deletion deadline, the navigation device 1 updates the deletion deadline for the destination candidate to the date that is m months after the current date, thus extending the deletion deadline. This postpones the deletion of a destination candidate that the user deems to be necessary.

This procedure makes it possible for the navigation device 1 to delete the destination candidate after retaining it for a fixed time period. Moreover, while the destination candidate is being retained for the fixed time period, it can be found by searches and displayed in lists, but the navigation device 1 makes the user aware that the destination candidate is eligible for deletion by changing the way that the destination candidate is displayed or the like.

FIG. 1 is a system configuration diagram of an exemplary navigation device 1 that uses a destination input device and a destination input program. The navigation device 1 is installed in a vehicle and, as shown in FIG. 1, includes a current position detection device 10, a controller (e.g. an information processing control device 20), input-output devices 40, and an information storage device 50. An example of each of these devices is described below.

A configuration of the current position detection device 10, which functions as a current position acquisition unit, is described below. The current position detection device 10 includes, for example, an absolute heading sensor 11, a relative heading sensor 12, a distance sensor 13, a GPS receiving device 14, a beacon receiving device 15, and a data transmitting receiving device 16.

The absolute heading sensor 11 is a geomagnetic sensor that detects the direction in which the vehicle is facing, by using a magnet to detect the direction north, for example. The absolute heading sensor 11 may be any unit that detects an absolute heading.

The relative heading sensor 12 is a sensor that detects, for example, whether or not the vehicle has turned at an intersection. It may be an optical rotation sensor that is attached to a rotating portion of the steering wheel, a rotating type of resistance volume, or an angle sensor that is attached to a wheel portion of the vehicle. For example, a gyroscopic sensor that utilizes angular velocity to detect a change in an angle may also be used. In other words, the relative heading sensor 12 may be any unit that can detect an angle that changes in relation to a reference angle (the absolute heading).

The distance sensor 13 may be, for example, a unit that detects and measures a rotation of a wheel or a unit that detects an acceleration and derives its second integral. In other words, the distance sensor 13 may be any unit that can measure a distance that the vehicle moves.

The GPS receiving device 14 is a device that receives a signal from a man-made satellite. It can acquire various types of information, such as a signal transmission time, information on the position of the receiving device 14, a movement velocity of the receiving device 14, a direction of movement of the receiving device 14, and the like.

The beacon receiving device 15 is a device that receives a signal that is transmitted from a transmission device that is installed at a specific location. Specifically, the beacon receiving device 15 can obtain information that pertains to the vehicle's operation, such as VICS information, information on traffic congestion, information on the vehicle's current position, parking information, and the like.

The data transmitting-receiving device 16 is a device that utilizes a telephone circuit or radio waves to perform communication and exchange information with other devices outside the vehicle. For example, a data transmitting-receiving device 16 may be used in a variety of ways, such as for a car telephone, ATIS, VICS, GPS route correction, inter-vehicle communication, and the like, and is capable of inputting and outputting information that relates to the operation of the vehicle.

The information processing control device 20 and its configuration is described below. The information processing control device 20 performs calculations and control based on information that is input from the current position detection device 10 and the input-output devices 40, as well as on information that is stored in the information storage device 50. The information processing control device 20 is also a unit that performs control such that calculation results are output to an output unit such as a display 42, a printer 43, a speaker 44, or the like.

The information processing control device includes, for example, a central processing unit (CPU) 21, a first ROM 22, a sensor input interface 23, a RAM 24, a communication interface 25, and a second ROM 26.

The CPU 21 performs overall calculations and control for the entire navigation device 1.

The first ROM 22 stores programs that are related to navigation, specifically, in the present embodiment, navigation programs that are related to a process of inputting the destination by inputting the name before it was changed or the name after it was changed, to current position detection, to route searching, to displayed guidance, and the like.

The sensor input interface 23 is a unit that receives information from the current position detection device 10.

The RAM 24 stores information that a user inputs, such as an input from an input device 41 that is described later, as well as destination information, information on a point that the vehicle passes, and the like. The RAM 24 is also a storage unit for storing the results of calculations that the CPU 21 makes based on the information that is input by the user, route search results, and map information that is read in from the information storage device 50. Furthermore, the destination names and the like are stored as destination candidates in the RAM 24.

The communication interface 25 is a unit that inputs and outputs information from the current position detection device 10, particularly information that is acquired from outside the vehicle. The second ROM 26 stores programs that are related to navigation, specifically a navigation program that is related to voice guidance. The image processor 27 is a processing unit that takes vector information that is processed by the CPU 21 and processes it into image information. The clock 28 keeps time. The image memory 29 is a unit that stores the image information that the image processor 27 processes. The audio processor 30 processes audio information that is read in from the information storage device 50 and outputs it to the speaker 44.

The input-output devices 40 include, for example, an input device 41, a display 42, a printer 43, and a speaker 44. The user uses the input device 41 to input data such as a destination, a point that the vehicle passes, a search condition, and the like. The display 42 displays an image. The printer 43 prints information. The speaker 44 outputs the audio information. The input device 41 may be a touch panel that is provided on the face of the display 42, a touch switch, a joystick, a key switch, or the like.

A map of the area around the current position, various types of operation screens, and a driving route to the destination are displayed on the display 42. Also displayed on the display 42 are operation screens, such as a character input screen for inputting the search characters that are used in the destination input process according to the present embodiment, a candidate display screen that displays a list of search candidates (destination candidates), and the like. Touching a position that corresponds to an item or the like that is displayed on an operation screen causes the item in the touched position to be input from the touch panel that is provided on the screen of the display 42.

The information storage device 50 is connected to the information processing control device 20 through a transmission line 45. The information storage device 50 stores, for example, a map data file 51, an intersection data file 52, a node data file 53, a road data file 54, a photographic data file 55, a destination data file 56, a guidance point data file 57, and an other data file 59. The information storage device 50 is generally configured from an optical storage medium such as a DVD-ROM or a CD-ROM, or from a magnetic storage medium such as a hard disk or the like, but it may also be configured from any one of various types of storage media, such as a magneto optical disk, a semiconductor memory, or the like.

The map data file 51 stores map data such as a national road map, road maps of various regions, residential maps, and the like. The road maps include various types of roads, such as main arterial roads, expressways, secondary roads, and the like, as well as terrestrial landmarks (facilities and the like). The residential maps include graphics that show the shapes of terrestrial structures and the like, as well as street maps that indicate street names and the like. The secondary roads are comparatively narrow roads with rights of way that are narrower than the prescribed values for national routes and prefectural routes. They include roads for which traffic restriction information is not added, such as “one-way” and the like.

The intersection data file 52 stores data that is related to intersections, such as geographical coordinates for the locations of intersections, intersection names, and the like.

The node data file 53 stores geographical coordinate data and the like for each node that is used for route searching on the map.

The road data file 54 stores data that is related to roads, such as the locations of roads, the types of roads, the number of lanes, the connection relationships between individual roads, and the like.

The photographic data file 55 stores image data of photographs taken of locations that require visual display, such as various types of facilities, tourist areas, major intersections, and the like.

The guidance point data file 57 stores guidance data on geographical points where guidance is required, such as the content of a guidance display sign that is installed on a road, guidance for a branching point, and the like.

The destination data file 56 stores the destination data on the destination candidates that are eligible for the destination searches, such as data on major tourist areas, buildings, facilities, locations such as companies, sales offices, and the like that are listed in telephone directories and that can be selected as destinations, and the like. The destination data includes search keys (phonetic representations of names) and information on facilities. The information on the facilities includes names, coordinates, telephone numbers, additional information, and the like. The coordinates are x and y coordinates that are derived from the latitudes and longitudes of the destinations. The additional information is detailed data that is related to the destinations.

The navigation device 1 is also provided with a destination candidate storage unit that stores a destination candidate for which a search expiration date is set. The effective period can be set for a destination candidate. For a destination candidate for which the effective period is set, a deletion deadline is also set, indicating the date on which the effective period and the corresponding destination data will be deleted from the destination data file 56. The deletion deadline is the last day of the period during which a search can find the destination candidate, so it also functions as a search expiration date. In addition, for facilities that are chain stores, the destination data includes data that links the facilities with one another and groups them, and also includes a representative name for the group. In this manner, groups are set for some of the destination candidates.

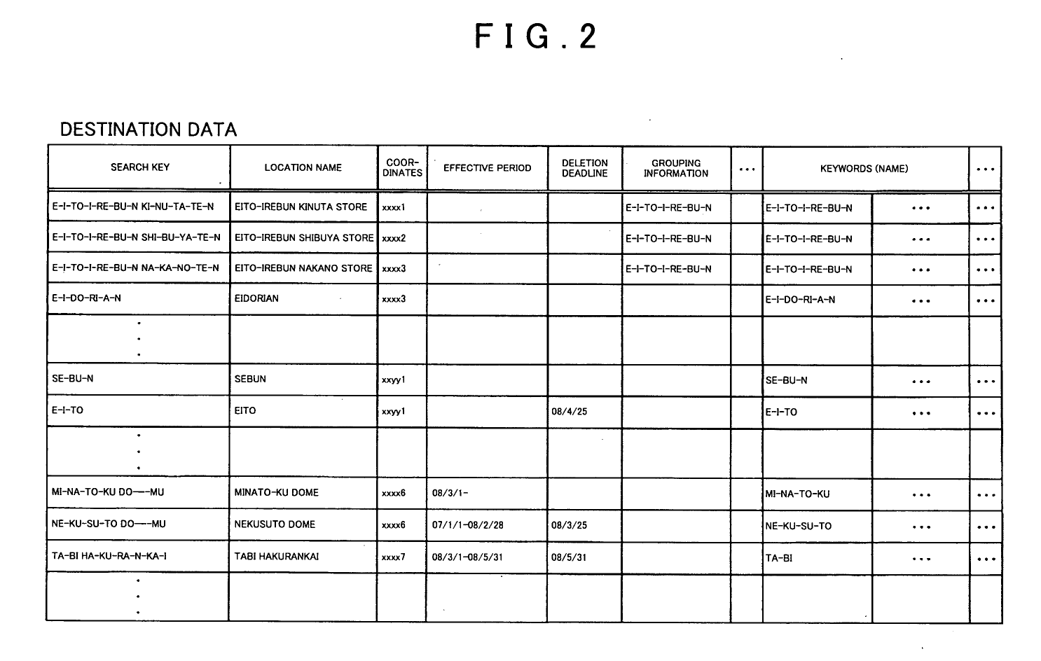

FIG. 2 illustrates an example of a logical structure of the destination data file 56. The destination data file 56 specifies each of the destination candidates in terms of, for example, a location name, a search key, coordinates, a telephone number (not shown in FIG. 2), the effective period, the deletion deadline, grouping information, keywords, and the like.

The location name is a character string that describes the destination candidate and is used in displaying the search results on the candidate display screen 60, which is described later. The search key is the phonetic representation of the location name.

Note that there are two methods for setting a search term in the navigation device 1. The first method is character input, where the user sets the search term by inputting characters directly. The second method is keyword input, where the user sets the search term by selecting a keyword that has been prepared in advance. When the search term is input as characters, the search is conducted for a character string that corresponds to the search key. The search operates such that it finds names that start with a character string that matches the search key. However, the search may also operate such that, for example, the search term “su-pa-e-i-to” is divided into the segments “su-pa” and “e-i-to,” which are then stored in memory. Any name that matches one of the segments, such as “e-i-to,” for example, is treated as a match for the search term “su-pa-e-i-to.”

The coordinates are coordinate values for the location, such as the latitude, longitude, or the like. The telephone number is the telephone number of the facility at the location. The navigation device 1 can calculate the distance from the vehicle to the destination candidate based on the coordinates of the current position and the coordinates in the destination data.

The effective period, if there is one, is stored in the effective period field. If the name of the destination candidate (the name that is stored as the location name) has been changed, then the effective period specifies the period during which the name is search-eligible. For a destination candidate for which there is no limit on the effective period, the field is left blank. The effective period is stored in the effective period field in if, for example, a naming rights business, a limited-duration event, or the like, has put the location name in effect for a fixed period. If a destination candidate will become effective at a certain time in the future, then the date on which it will become effective is stored in the effective period field. If a destination candidate for which the effective period has not yet begun, that is, for a destination candidate that will become effective on a certain date in the future, then the navigation device 1 will treat the destination candidate as search-eligible starting on that future date.

For example, in FIG. 2, the destination candidates with the location names “Minato-Ku Dome” and “Nekusuto Dome” are examples where, as a result of a naming rights change, the name of a facility is “Nekusuto Dome” from Jan. 1, 2007 to Feb. 28, 2008, and then becomes “Minato Dome” on Mar. 1, 2008. Because the coordinates for the two destination candidates are the same, the navigation device 1 can recognize that they are the same facility. For the destination candidate with the location name “Tabi Hakurankai,” the effective period is from March 1 to May 31, 2008, the period during which the event takes place.

Note that in FIG. 2, the year 2008 is abbreviated to “08” to save space. Thus, a destination candidate for which the effective period has been set is treated as search-eligible after the effective period begins, but a destination candidate for which the effective period has not yet begun is stored in a separate file and is moved to the destination data file 56 after its effective period begins.

The deletion deadline is the deadline for deleting the destination candidate from the destination data file 56. The navigation device 1 searches through the deletion deadlines in the destination data file 56 at one of regular intervals and irregular intervals. If a destination candidate is found for which the deletion deadline has passed, then the navigation device 1 deletes the destination candidate from the destination data file 56.

Thus, the navigation device 1 is provided with an expired destination candidate identification unit that identifies a destination candidate for which the search expiration date (the deletion deadline) has passed. The navigation device 1 is also provided with a deletion unit that deletes from the expired destination candidate identification unit (the destination data file 56) the destination candidate for which the search expiration date (the deletion deadline) has passed. For a destination candidate for which the effective period is set, such as the above-listed Nekusuto Dome and Tabi Hakurankai, the default value for the deletion deadline is set to the final day of the effective period. Thus, if the location name is changed for a business reason or the like, but the effective period is not set, then the navigation device 1 sets the deletion deadline as described below.

The navigation device 1 updates the destination data file 56 to the most current state by accessing a server, for example, at one of regular intervals and irregular intervals. Where an old destination candidate is replaced by a new destination candidate (which can be recognized by checking the coordinates to confirm that the location is the same), the new destination candidate is stored in the destination data file 56, but the old destination candidate is not deleted. Instead, the deletion deadline for the old destination candidate is set to a default value that is a fixed time period after the update date. The period may be, for example, n months after the update date, where n is an integer, such as 2. Because the new destination candidate and the old destination candidate for the same location are both stored for a period of n months, the user can search for the location during this period using either the old or the new search key.

As described above, for both a destination candidate for which the effective period is set and an old destination candidate that has been replaced by a new destination candidate, the deletion deadline is set to the default value. However, the deletion deadline can be extended by updating as described below.

Specifically, if the user sets as the destination a destination candidate for which the deletion deadline is set, then the navigation device 1 compares the deletion deadline to a date that is a fixed time period after the date when the destination is set. The period may be, for example, m months, where m is an integer, such as 3. If the date at the end of the fixed period is later than the deletion deadline, then the navigation device 1 updates the deletion deadline to the date that is m months after the date when the destination is set. Thus, when a destination candidate for which the deletion deadline has been set is set as the destination, the navigation device 1 extends the deletion deadline if the conditions described above are fulfilled.

In the example in FIG. 2, when the navigation device 1 adds the destination candidate with the location name “Sebun” to the destination data file 56, it recognizes that the destination candidate “Sebun” indicates the destination that was originally called “Eito”, because the coordinates are the same. Instead of deleting the destination candidate “Eito”, the navigation device 1 sets the deletion deadline for “Eito” to Apr. 25, 2008, which is n months after the update date on which the destination candidate “Sebun” was added. Thereafter, if the destination is set to “Eito,” then the navigation device 1 compares Apr. 25, 2008 to the date that is m months after the date when the destination is set, and if the date that is m months after the setting date is later than Apr. 25, 2008, then the navigation device 1 updates the deletion deadline for “Eito” to the date that is m months after the setting date.

Note that the default deletion deadline for the destination candidate with the location name “Nekusuto Dome” was Feb. 28, 2008, but it has been extended to Mar. 25, 2008. Note also that the destination candidate with the location name “Tabi Hakurankai” was not set as the destination within m months before May 31, 2008, which is the default deletion deadline, so the deletion deadline remains unchanged at the default value.

In this example, the deletion deadline is set to the date that is m months after the setting date, but this is merely one example, and various modified examples are possible, such as the last day of the month in which the date that is m months after the setting date falls, or the like.

For a destination candidate for which the effective period is not set as described above, such as a supermarket, a convenience store, or the like, the deletion deadline is set to one of m months after the deletion deadline date and m months after the date that the user last set the destination candidate as the destination, whichever is later. For a destination candidate for which the effective period is set, such as a destination candidate that is related to an event or naming rights, the deletion deadline is set to one of m months after the last day of the effective period and m months after the date that the user last set the destination candidate as the destination, whichever is later. Thus, the navigation device 1 is provided with an extension unit that extends the search expiration date for the destination candidate if the destination candidate is set as the destination within a specified period (in this case, m months) before the search expiration date (the deletion deadline) that is set for the destination candidate, because the deletion deadline is extended if the destination candidate is set as the destination within m months before the deletion deadline for the destination candidate.

The grouping information is information for grouping the destination candidates. It is expressed in the form of the phonetic representation of the representative name for the destination candidates. The grouping information is used to group destination candidates that are strongly related, such as chain stores and the like. For example, the destination candidates “Eito-Irebun Kinuta Store,” “Eito-Irebun Shibuya Store,” and the like are grouped by the phonetic representation of the representative name “e-i-to-i-re-bu-n” in the grouping information.

The navigation device 1 sets the same effective periods and the same deletion deadlines for all of the destination candidates that are grouped into one group by the grouping information. If the deletion deadline is extended for any one of the destination candidates in the group, the navigation device 1 also extends the deletion deadlines for all of the other destination candidates that belong to the group. For example, the same deletion deadline is set for each of the stores that are grouped under “Eito-Irebun”. When the deletion deadline is extended for the “Eito-Irebun Kinuta Store” within the group, the navigation device 1 extends the deletion deadlines for all of the other destination candidates that belong to the group, for example, the “Eito-Irebun Shibuya Store.” If the name of the store chain is changed, then the extending of the deletion deadlines makes it possible to search for any of the stores in the chain by using the old name. For example, if the user has moved to a new address, then the user can use the old name to search for the same chain stores, whether in his new area, his former area, or elsewhere. As described above, groups are set for some of the destination candidates. When a destination candidate for which the search expiration date is extended belongs to a group, the navigation device 1 also extends the search expiration dates for all of the destination candidates that belong to the group.

The keywords are keywords that are set for the location name. The keywords are set for the three attributes of name, address, and genre. For example, the user can search for destinations by genre by selecting a genre and the associated keywords. Note that in FIG. 2, the keywords for the name are shown, but the keywords that pertain to the address and the genre have been omitted.

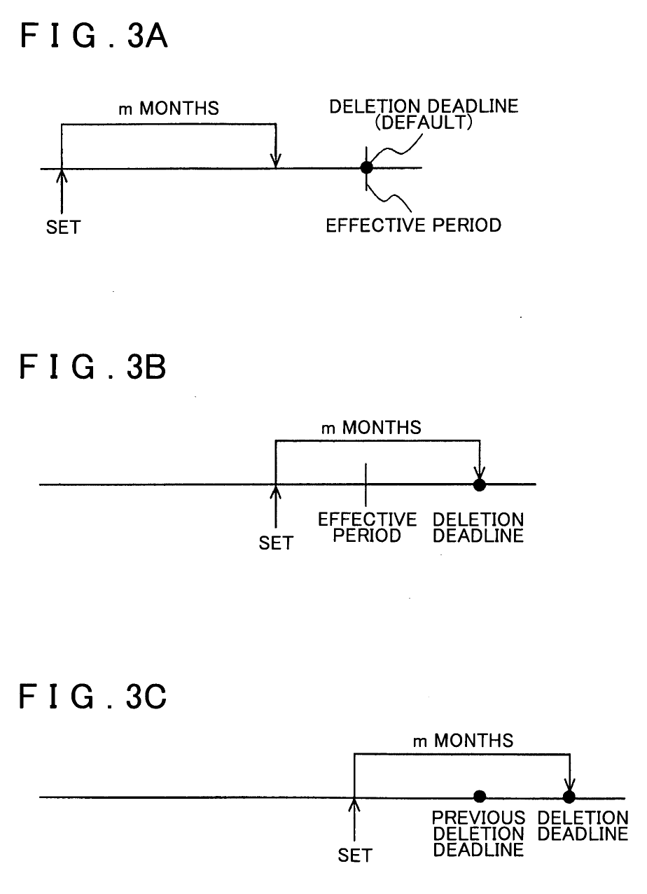

FIGS. 3A to 3C are conceptual diagrams illustrating the method of extending the deletion deadline for a destination candidate for which the effective period is set. In FIG. 3A, the deletion deadline for the destination candidate is set by default to the last day of the effective period. For example, in a case where the user sets the destination candidate as the destination, and the date that is m months after the date that the destination was set falls before the deletion deadline, the deletion deadline is not extended. On the other hand, FIG. 3B illustrates a case where the user sets the destination candidate as the destination, and the date that is m months after the date that the destination was set falls after the deletion deadline, the navigation device 1 extends the deletion deadline to the date that is m months after the destination setting date. Finally, FIG. 3C illustrates a case where the user sets the destination candidate as the destination, if the date that is m months after the setting date falls after the extended deletion deadline, the navigation device 1 extends the deletion deadline to the date that is m months after the setting date. In this manner, when the destination candidate is set as the destination, the navigation device 1 extends the deletion deadline for the destination candidate in units of m months.

The above illustrations apply to cases where a destination candidate has a set effective period. When a destination candidate is set but does not have a set effective period, the navigation device 1 performs processing like that shown in FIG. 3C. In other words, for a destination candidate for which the effective period is set, the navigation device 1 takes the date that is m months after the setting date and compares it to the last day of the effective period (the default value for the deletion deadline). In a case where the deletion deadline has already been extended, the date that is m months after the setting date is compared to the extended deletion deadline. For a destination candidate for which the effective period is not set, the navigation device 1 takes the date that is m months after the setting date and compares it to the deletion deadline.

In both of the above cases, the navigation device 1 compares the deletion deadline and the date that is m months after the setting date, and if the date that is m months after the setting date is later than the deletion deadline, then the navigation device 1 extends the deletion deadline. In other words, if the destination candidate is set as the destination within m months before the deletion deadline, then the navigation device 1 extends the deletion deadline for the destination candidate. In this manner, the navigation device 1, under a specified condition, takes a destination candidate that the user is using and makes it search-eligible instead of deleting it, even though it is eligible for deletion.

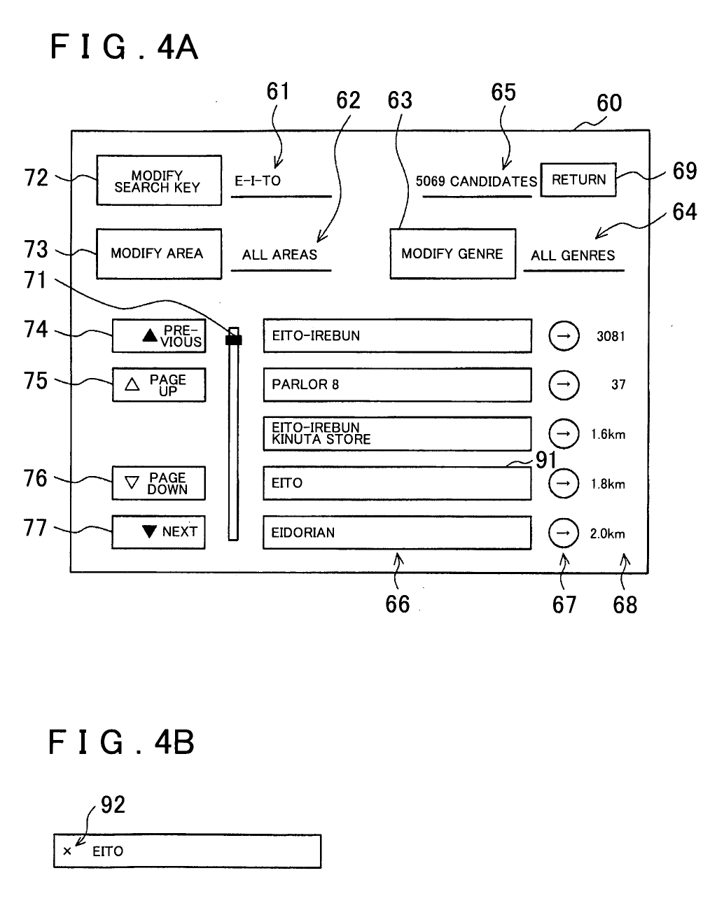

FIG. 4 shows an exemplary candidate display screen 60. As shown in FIG. 4, the candidate display screen 60 may include, for example, a search key space 61, an area input space 62, a Modify Genre button 63, a genre input space 64, a total number of candidates space 65, search results display spaces 66, detail display buttons 67, comment spaces 68, a Return button 69, a scroll bar 71, a Modify Search Key button 72, a Modify Area button 73, a Previous button 74, a Page Up button 75, a Page Down button 76, and a Next button 77 are displayed on the candidate display screen 60.

The search key space 61 is a space that displays the search key for the performed search. The input characters that were input on the character input screen, which is not shown in the drawings, are displayed as the search key in the search key space 61.

The Modify Search Key button 72 is a button that is touched in order to modify the characters that are displayed in the search key space 61. When the Modify Search Key button 72 is touched, the display returns to the character input screen, and it becomes possible to modify the characters that are displayed in the search key space 61. Thus the navigation device 1 is provided with a search term input device that inputs the search term (the search key).

The area input space 62 is a space for setting a search area within which the search for the destination data will be performed. For example, the area may be set to “All areas” to define the entire country as the search area, and the area may also be set to a smaller area, such as “Osaka Prefecture”, Aichi Prefecture”, “Tokyo Metropolitan”, or the like. A search area setting menu is provided as a part of the destination input process, although it is not shown in the drawings. The user can thereby select the desired search area. The navigation device 1 uses the destination data for the area that is set in the area input space 62 and narrows down the destination candidates in the area according to the search key.

The Modify Area button 73 is a button that is touched to modify the search area that is set in the area input space 62. When the Modify Area button 73 is touched, it becomes possible to modify the search area that is set in the area input space 62. After the search area is modified, a search of the modified area is performed using the search key that is displayed in the search key space 61.

The genre input space 64 is a space for setting a genre within which the search for the destination data will be performed. For example, the genre may be set to “all genres”, “leisure”, “restaurants”, “hotels”, or the like. A genre setting menu is provided as a part of the destination input process, although it is not shown in the drawings. The user can therefore select the desired genre. The navigation device 1 uses the destination data for the genre that is set in the genre input space 64 and narrows down the destination candidates in the genre according to the search key.

The Modify Genre button 63 is a button that is touched to modify the genre that is set in the genre input space 64. When the Modify Genre button 63 is touched, it becomes possible to modify the genre that is set in the genre input space 64. After the genre is modified, a search of the modified genre is performed using the search key that is displayed in the search key space 61.

By using the search area and the genre as described above to narrow down the destination data that is the object of the search, the navigation device 1 reduces the amount of the search processing.

The total number of candidates space 65 displays the total number of the destination candidates that have been selected. The total number of the destination candidates is the sum of the number of the destination candidates that were selected by the ordinary search and the number of the destination candidates that were selected by the fuzzy search. Note that the numbers of the destination candidates that were selected by each of the searches may also be displayed separately.

The search results display spaces 66 are spaces for displaying in list form the names of the destination candidates that are found by the search. Thus the navigation device 1 is provided with a search unit that uses the inputted search term to search for the destination candidates in the destination candidate storage unit (the destination data file 56). The navigation device 1 is also provided with a destination candidate display unit that displays the found destination candidates.

The methods for displaying the destination candidates in the search results display spaces 66 include an ordinary display and an extended display. The ordinary display displays the destination candidate in an ordinary form and is used to display a destination candidate for which the deletion deadline is not set, as well as a destination candidate for which the deletion deadline is set, but for which the default deletion deadline has not passed. In contrast, the extended display is used to display a destination candidate for which the default deletion deadline has passed. It displays the destination candidate in a form that is different from the ordinary display, for example, by dimming the display.

In the example in FIG. 4A, the destination candidate “Eito” is displayed more dimly than the other destination candidates to alert the user that “Eito” would normally be deleted. Thus, the navigation device 1 can display a destination candidate for which the search expiration date has not yet been reached in a form that is different from the form used to display a destination candidate for which the search expiration date has not been set.

In addition, the navigation device 1 can be configured to use the extended display to add to the destination candidate an additional display, for example, a removal mark 92 or the like, as shown in FIG. 4B.

The navigation device 1 may also be provided with a search expiration date passed notification unit that, in a case where a destination candidate for which the search expiration date has passed is set as the destination, provides a notification that the search expiration date for the destination candidate has passed. For example, the navigation device 1 can also be configured to make the user aware that a destination candidate is eligible for deletion by providing a warning when the user sets the destination candidate as the destination and requiring the user to take a particular action in order to make the setting, such as pressing and holding a button, pressing a button twice, or the like.

The navigation device 1 is provided with a setting unit that sets as the destination a destination candidate that has been found by the search. For example, if a destination candidate that is displayed in the search results display spaces 66 as described above is selected (touched), then the navigation device 1 sets the selected destination candidate as the destination for which guidance is provided.

Returning to FIG. 4A, one of the detail display buttons 67 is displayed for each of the destination candidates. When the user touches the detail display button 67 for the desired destination candidate, the navigation device 1 searches the destination data file 56 for the facilities information that is associated with the selected destination candidate and displays the facilities information on the display 42. In a case where the destination candidate is a display of a representative name for destination candidates that are grouped by the grouping information, the comment space 68 displays the number of the destination candidates that belong to the group. In a case where the destination candidate is displayed individually, the comment space 68 displays the distance from the current position to the destination candidate. The navigation device 1 has a function that takes the destination candidates that are grouped by the grouping information and displays them under the representative name.

The Return button 69 is a button for returning to the character input screen, which is the previous screen to the candidate display screen 60. The Previous button 74 and the Next button 77 are buttons for respectively scrolling up and scrolling down within the search results display spaces 66, one display at a time. The Page Up button 75 and the Page Down button 76 are buttons for respectively scrolling up and scrolling down within the search results display spaces 66, one page at a time. The scroll bar 71 indicates the position of the currently displayed destination candidates among all of the destination candidates. Scrolling up and scrolling down can be done by touching and dragging the scroll bar 71.

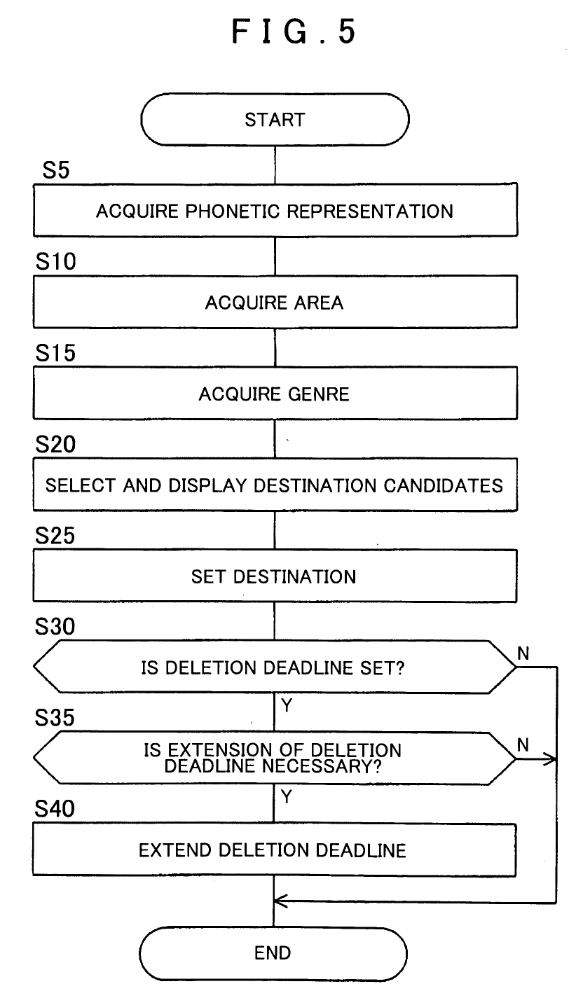

Next, a destination selection method will be described with reference to FIG. 5. The exemplary method may be implemented, for example, by one or more components of the above-described navigation device 1. For example, the exemplary method may be implemented by the CPU 21 and or information processing control device 20 executing a computer program stored in the first ROM 22, second ROM 26, and/or the information storage device 50. However, even though the exemplary structure of the above-described navigation device 1 may be referenced in the description, it should be appreciated that the structure is exemplary and the exemplary method need not be limited by any of the above-described exemplary structures.

As shown in FIG. 5, the navigation device 1 acquires the phonetic representation in the search key space 61 on the candidate display screen 60 (FIG. 4A) (step 5), acquires an area that is input in the area input space 62 (step 10), and acquires a genre that is input in the genre input space 64 (step 15). Next, the navigation device 1 uses the acquired information to select the destination candidates from the destination data file 56 and displays them in the search results display spaces 66 (step 20). If the user touches any one of the destination candidates that are displayed in the search results display spaces 66, the navigation device 1 sets the touched destination candidate as the destination (step 25). When the destination is set in this manner, the navigation device 1 determines whether or not the deletion deadline is set in the destination data file 56 for the destination candidate that is set as the destination (step 30). In a case where it is determined that the deletion deadline is not set for the destination candidate (NO at step 30), the navigation device 1 ends the processing. On the other hand, in a case where it is determined that the deletion deadline is set for the destination candidate (YES at step 30), the navigation device 1 determines whether or not it is necessary to extend the deletion deadline (step 35).

The navigation device 1 makes this determination as described below. The navigation device 1 calculates the date that is m months after the current date, then compares that date to the deletion deadline. In a case where the date that is m months after the current date is later than the deletion deadline, the navigation device 1 determines that it is necessary to extend the deletion deadline, and in a case where the date that is m months after the current date is not later than the deletion deadline, the navigation device 1 determines that it is not necessary to extend the deletion deadline (step 35). In a case where the navigation device 1 determines that it is not necessary to extend the deletion deadline (NO at step 35), the navigation device 1 ends the processing without extending the deletion deadline. On the other hand, in a case where the navigation device 1 determines that it is necessary to extend the deletion deadline (YES at step 35), the navigation device 1 extends the deletion deadline for the destination candidate by updating the deletion deadline in the destination data file 56 to the date that is m months after the current date (step 40), then ends the processing.

Exemplary implementations of the broad inventive principles described can provide at least the effects described herein below. (1) In a case where the destination data in the destination data file 56 is updated, the destination data that pertains to an old destination candidate can be retained in the file for a fixed period of time, without being deleted, by setting the deletion deadline. (2) Because both the new and old sets of the destination data are stored up until the deletion deadline, it is possible to use either one of the data sets to search for the destination candidate. (3) Setting the deletion deadlines for the destination candidates makes it possible to delete from the destination data file 56 a destination candidate that is no longer needed. (4) In a case where a destination candidate for which the deletion deadline has been set is set as the destination, the deletion deadline can be extended under a specified condition. (5) Extending the deletion deadline for a destination candidate on the condition that the destination candidate is set as the destination makes it possible to retain a destination candidate that the user deems to be necessary and to delete a destination candidate that the user deems to be unnecessary. (6) Taking a destination candidate for which the deletion deadline has been extended and displaying it in a form that is different from the form in which an ordinary destination candidate is displayed makes it possible to make the user aware that the destination candidate is eligible for deletion.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying inventive principles.

What is claimed is:

1. A destination search support device usable in a navigation device, comprising:
an information storage unit that stores a plurality of destination candidates for which search expiration dates are set; and
a controller that:
inputs a search term;
searches among the destination candidates in the information storage unit for the destination candidates that correspond to the search term;
sets one of the destination candidates that is found by the search as a destination;
extends the search expiration date for the destination candidate when the controller sets the destination candidate as the destination within a specified period before the search expiration date that is set for the destination candidate; and
deletes from the information storage unit the destination candidates for which the search expiration dates have passed.

2. The destination search support device according to claim 1, wherein the controller:
identifies the destination candidates for which the search expiration dates have passed, and
deletes the identified destination candidates.

3. The destination search support device according to claim 1, wherein:
a group is set for at least two of the destination candidates, and
the controller extends the search expiration dates for all of the destination candidates that belong to the group when the controller extends the search expiration date for one of the destination candidates that belongs to the group.

4. The destination search support device according to claim 1, wherein the controller displays the destination candidates that are found by the search.

5. The destination search support device according to claim 4, wherein the controller displays the destination candidates for which the search expiration date has not been set in a different form from the destination candidates for which the search expiration date has not yet passed.

6. The destination search support device according to claim 1, wherein the controller provides a notification that the search expiration date for the destination candidate has passed when a destination candidate for which the search expiration has passed is set as the destination.

7. A method of selecting a destination, usable in a navigation device, comprising:
storing a plurality of destination candidates for which search expiration dates are set;
inputting a search term;
searching among the stored destination candidates for destination candidates that correspond to the search term;
setting as a destination one of the destination candidates that is found by the search;
extending the search expiration date for the destination candidate when the destination candidate is set as the destination within a specified period before the search expiration date that is set for the destination candidate; and
deleting from the destination candidates for which the search expiration dates have passed,
wherein the navigation device comprises an information storage unit and a controller.

8. The method of selecting a destination according to claim 7, further comprising:
identifying the destination candidates for which the search expiration dates have passed, and
deleting the destination candidates that are identified.

9. The method of selecting a destination according to claim 7, further comprising:
setting as a group at least two of the destination candidates, and
extending the search expiration dates for all of the destination candidates that belong to the group when the controller extends the search expiration date for one of the destination candidates that belongs to the group.

10. The method of selecting a destination according to claim 7, further comprising:
displaying the destination candidates that are found by searching.

11. The method of selecting a destination according to claim 7, further comprising:
displaying the destination candidates for which the search expiration date has not been set in a different form from the destination candidates for which the search expiration date has not yet passed.

12. The method of selecting a destination according to claim 7, further comprising:
providing a notification that the search expiration date for the destination candidate has passed when a destination candidate for which the search expiration has passed is set as the destination.

13. A computer-readable storage mediums storing a computer-executable program usable to control a destination search support program that comprises an information storage unit that stores a plurality of destination candidates for which search expiration dates are set, the program comprising:
instructions for inputting a search term;
instructions for searching for the destination candidates that correspond to the search term among the destination candidates in the information storage unit;
instructions for setting as a destination one of the destination candidates that are found by the search;
instructions for extending the search expiration date for the destination candidate when the destination candidate is set as the destination within a specified period before the search expiration date that is set for the destination candidate; and
instructions for deleting from the information storage unit the destination candidates for which the search expiration dates have passed.
